(19) United States
(12) Patent Application Publication
(10) Pub. No.: US 2012/0187136 A1
(43) Pub. Date: Jul. 26, 2012

(54) SEGMENTED REFRESHMENT HOLDER

(76) Inventor: Larry Smith, Menomonee Falls, WI (US)

(21) Appl. No.: 13/013,397

(22) Filed: Jan. 25, 2011

(51) Int. Cl. B65D 25/00; A47B 23/00; F16M 11/04

(52) U.S. Cl. 220/739; 248/121; 211/107; 220/737

(57) ABSTRACT

Refreshment holders having a multiple element, segmented support pole that can be configured to hold accessories such as an inverted-plunger shaped beverage holder, trays, ice chests, buckets, and support stands. The refreshment holders holds beverages in an insulated beverage holder, small items such as nuts, dip, and chips, and ice.

### FIELD OF THE INVENTION

The presently disclosed subject matter is directed towards a refreshment holder for beer, soda, wine, fruit juices, and the like, as well as for nuts, chips, fruit slices, and ice.

### BACKGROUND OF THE INVENTION

Outdoor relaxation is a popular way of sharing time with family and friends. For example, going to the beach, a tailgate party, a child's ball game, or just to a barbecue at a neighbor can provide much needed entertainment, relaxation and fun.

When relaxing outdoors it is common to use outdoor recreational items such as lawn chairs, recliners, and ice chests that chill items such as beer, soda, sandwiches. An oft encountered problem when relaxing outdoors is that while one may have a cold beverage there is seldom a place to put it. If you hold it your hands they are tied up and cold. If you place a beverage on the ground it is likely to spill. Compounding the problem is when other consumables such as nuts, chips, dips, or sandwiches are available. There are seldom enough places within easy reach to put everything.

In the prior art are various types of beverage holders that are on the end of poles. While such beverage holders are generally successful, they usually do not solve the entire problem of holding ice and other items. While beverage holders on the ends of poles are known, those holders are usually not configurable by a user or manufacturer and thus lack use flexibility. In addition, some beverage holders on the end of poles do not insulate a beverage, but merely provide a place to hold a beverage.

Therefore, a configurable refreshment holder that includes a beverage holder on the end of a pole would be beneficial. Even more beneficial would be a configurable refreshment holder having a beverage holder on one end of a pole and an ice chest on the other end. Even more beneficial would be a configurable refreshment holder having a beverage holder on one end of a segmented pole, an ice chest at the other end, and a tray disposed between the ice chest and the beverage holder. Even more beneficial would be a configurable refreshment holder having a beverage holder on one end of a segmented pole, an ice chest at the other end, a tray disposed between the ice chest and the beverage holder, and the configurability to add additional item holders. Even more beneficial would be a configurable refreshment holder having a beverage holder on one end of a pole, an ice chest at the other end, a tray disposed between the ice chest and the beverage holder, and the configurability to add additional item holders, where the beverage holder insulates a beverage. Also beneficial would be a configurable beverage holder having a beverage holder in the general shape of an inverted plunger on one end of a segmented pole, an ice chest at the other end, a tray disposed between the ice chest and the beverage holder, where the inverted plunger shaped beverage holder provides for insulating a beverage.

### BRIEF SUMMARY OF THE INVENTION

The principles of the present invention provide for refreshment holders for holding beverages such as beer and soda, small item such as nuts and chips, and ice. The refreshment holder includes a segmented pole that can be taken apart and reconnected. The segmented pole attaches a beverage holder at one end, beneficially in the shape of an inverted-plunger, and a support stand at the other. Those items can be detached from the segmented pole. The support stand can take the form of an ice chest, a flat stand, a pointed base, or a tripod base. A tray, bowl, bucket or other item can be disposed below the beverage holder and above the stand. This is accomplished by taking the segmented pole apart, inserting the item having a hole between segmented pole pieces, and reconnecting the segmented pole together. The ice container can hold ice and beverages while the tray, bowl, or other item can hold nuts, dip, chips and sandwiches. Segmenting the support pole allows for easy assembly and reconfigurations of the refreshment holder, as well as the flexibility of configuring the refreshment holder to include additional item holders. Beneficially, the inverted plunger shaped beverage holder is insulating.

### BRIEF DESCRIPTION OF THE DRAWINGS

The advantages and features of the present invention will become better understood with reference to the following detailed description and claims when taken in conjunction with the accompanying drawings, in which like elements are identified with like symbols, and in which:

FIG. 1 is a perspective view of a first embodiment refreshment holder 10 having a segmented pole 13;

FIG. 2A is a perspective exploded view of a second embodiment refreshment holder 99 having a segmented pole 13;

FIG. 2B is a perspective of a third embodiment refreshment holder 100 having two beverage holders 102a and 102b that share an ice chest 58 and that has features on segmented poles 13;

FIG. 3A is a perspective view of a fourth embodiment refreshment holder 120 having a pointed base 74 on the end of a segmented pole 13; and

FIG. 3B is a perspective view of a fifth embodiment refreshment holder 130 having a tripod base 76 on the end of a segmented pole 13.

### DETAILED DESCRIPTION OF THE INVENTION

The presently disclosed subject matter now will be described more fully hereinafter with reference to the accompanying drawings in which multiple embodiments are shown. However, it should be understood that this invention may take many different forms and thus should not be construed as being limited to the specific embodiment set forth herein. Also, in the figures, like numbers refer to similar elements throughout, and the terms “a” and “an” do not denote a limitation of quantity, but rather denote the presence of at least one of the referenced items.

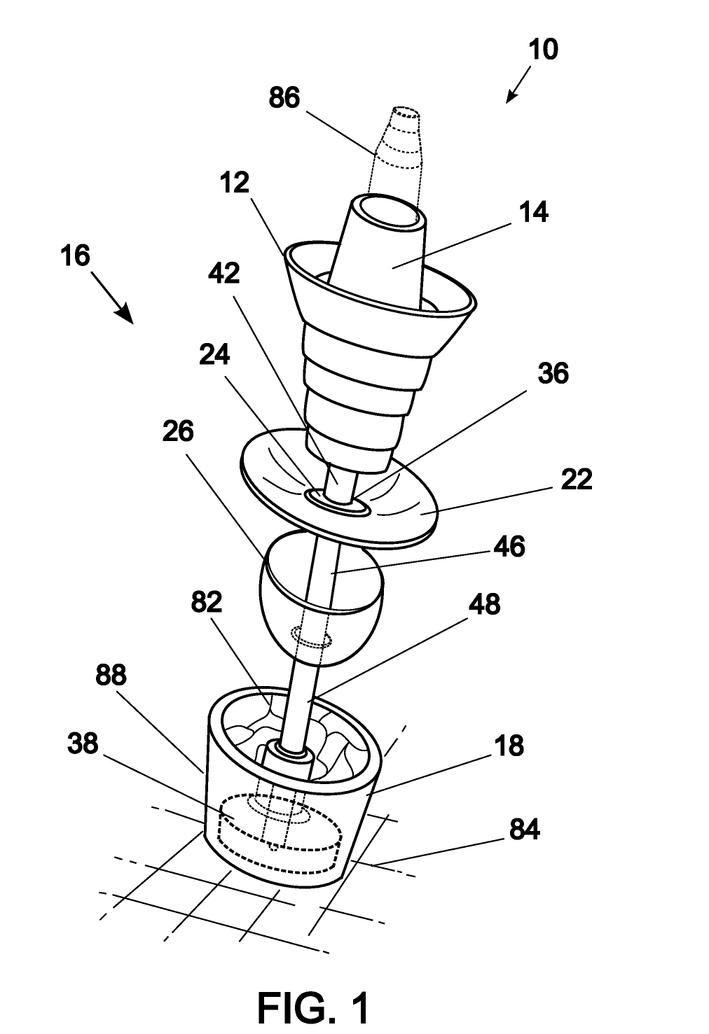

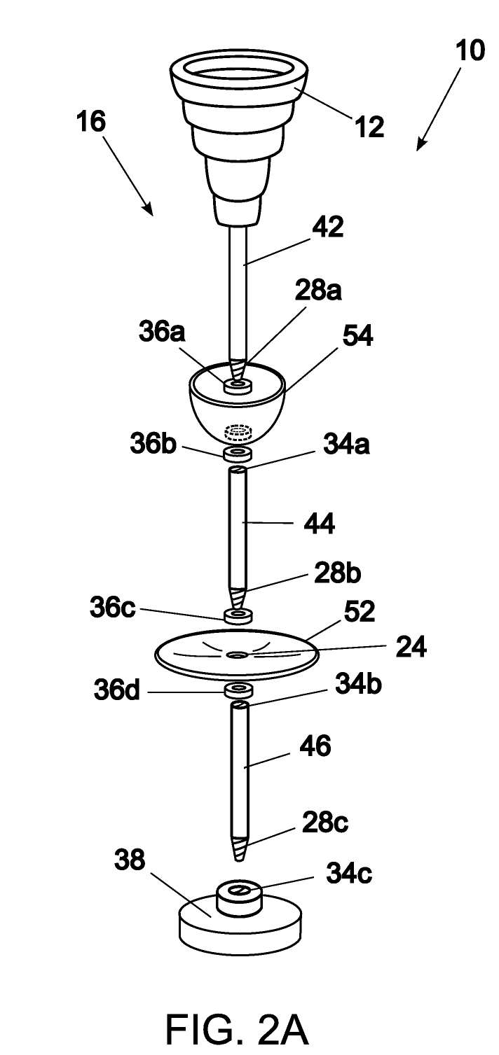

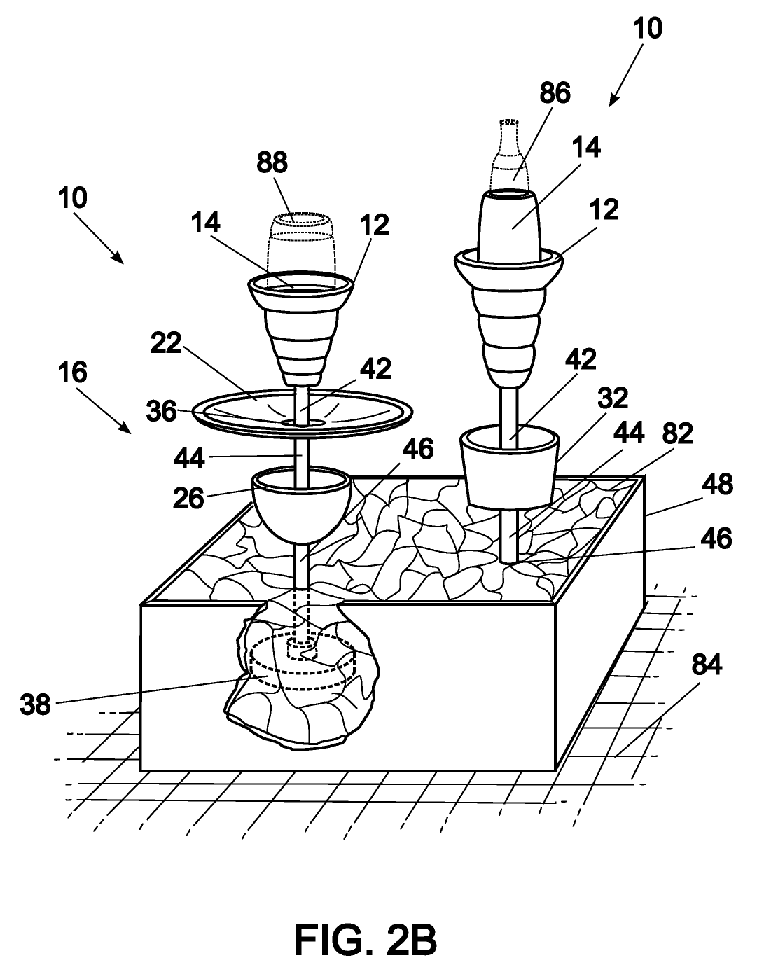

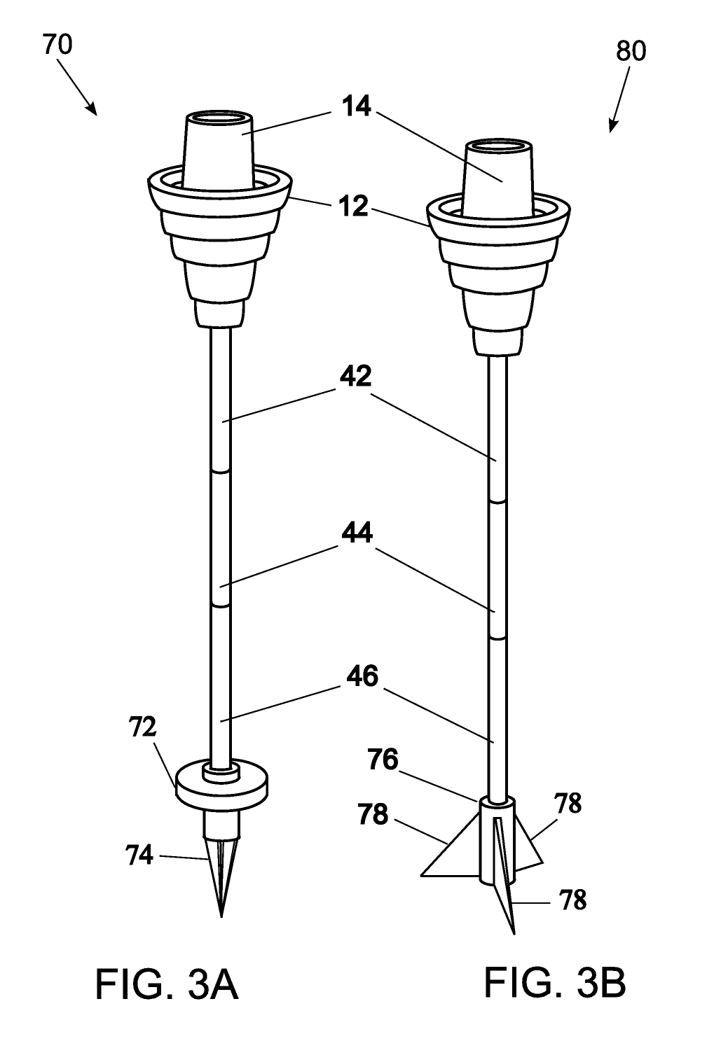

The principles of the present invention are described herein with reference to FIGS. 1 to 3B. Specifically, the FIGS. 1 through 3B illustrate refreshment holders 10 (FIG. 1), 99 (FIG. 2A), 100 (FIG. 2B), 120 (FIG. 3A), and 130 (FIG. 3B), all of which enable securely holding beverage holders 12 (FIGS. 1, 2B, 3A, and 3B) or 15 (FIGS. 2A and 2B) on the ends of segmented support poles 13. As described subsequently the segmented support poles 13 enable configuring the various refreshment holders to include additional features such as ice chests and trays.

FIG. 1 illustrates a perspective view of the first embodiment refreshment holder 10. The refreshment holder 10 includes an inverted-plunger shaped beverage holder 12 that is removably attached to the top end of a segmented support pole 13 (illustrated in more detail in FIG. 2A and described in more detail below). The inverted-plunger shaped beverage holder 12 includes an upwardly opening cone 14 having a chamber 19 that is configured to receive and hold a beverage container, such as a beer can, soda bottle, juice container, or such. In practice, the inverted-plunger shaped beverage holder 12 is primarily comprised of an elastomeric material such as rubber or plastic which by its nature provides insulation capabilities. However, the cone 14 may include additional insulation such as Styrofoam.

As noted above, the segmented support pole 13 is best illustrated in FIG. 2A. As shown in that figure, the segmented support pole 13 includes first pole section 42, a second pole section 44, and a third pole section 46. One end of the first pole section 42 terminates in a first male thread 28a which is configured to mate with a first female thread 34a at the top of the second pole section 44. The opposite end of the second pole section 44 terminates in a second male thread 28b. The second male thread 28b is configured to mate with a second female thread 34b at the top of the third pole section 46. The opposite end of the third pole section 46 terminates in a third male thread 28c. The third male thread 28c can mate with female threads elements 34c. Thus, in general, the segmented support pole 13 includes various male and female threads to allow the segmented pole 13 to be separated, items to be attached to and removed from the segmented support pole 13, and the segmented pole 13 to be reconstructed.

Turning back to FIG. 1, while not specifically shown, the top of the first pole section 42 includes a female thread 34c that mates to a male thread at the bottom end of the inverted-plunger shaped beverage holder 12. The inverted-plunger shaped beverage holder 12 is attached to the segmented support pole 13 using those threads.

The refreshment holder 10 includes a bowl 26 that is attached to the segmented support pole 13 between the second pole section 44 and the third pole section 46. This is accomplished by separating (unscrewing) the second pole section 44 from the third pole section 46, inserting the second male thread 28b through a center hole of the bowl 26, and then screwing the second pole section 44 and the third pole section 46 back together. If required, washers 36 (see FIG. 2A) can be used to assist assembly. The bowl 26 can be beneficially used to hold chips, dip, tacos, various sauces, and what-have-you.

Still referring to FIG. 1, the refreshment holder 10 also includes an ice chest 18 that is attached to the segmented support pole 13 using the third male thread 28c of the third pole section 46. Of course, while not specifically shown, the ice chest 18 includes a female thread 34c (see FIG. 2A) that mates with the third male thread 28c. The ice chest 18 is beneficially configured to allow the refreshment holder 10 to be self-standing on the ground 84. Ice 82 can be placed inside the ice chest 18 to keep beverages and other items cold.

The refreshment holder 10 also includes a tray 22 that is attached to the segmented support pole 13 below the inverted plunger-shaped beverage holder 12 and above the ice chest 18. The tray 22 is shown clamped to segmented support pole 13 between the first pole section 42 and the second pole section. This is accomplished by separating (unscrewing) the second pole section 44 from the first pole section 42, inserting the first male thread 28a through a center hole 24 of the tray 22, and then screwing the second pole section 44 and the first pole section 42 back together. If required, washers 36 can be used to assist assembly. The tray 22 is beneficial for holding small items such as nuts, keys, sandwiches, etc.

FIG. 2 shows a perspective exploded view of part of a refreshment holder 99 according to a second embodiment of the present invention. The refreshment holder 99 comprises the same segmented support pole 13 as described above with reference to FIG. 1. Thus, the segmented support pole 13 includes the first pole section 42, washers 36 as needed, the second pole section 44, the third pole section 46, and the tray 22. Furthermore, the pole sections 42, 44, 46 have ends comprising male threads 28a, 28b and 28c, respectively, and an opposing second end comprises corresponding female threads, one not being shown, 34a, and 34b.

However, since it is envisioned that refreshment holders according to the principles of the present invention can utilize a variety of accessories and be comprised of different combinations of those accessories, the refreshment holder 99 is shown as having an alternative inverted shaped plunger 15 and an alternate bowl 54, but does not include an ice chest 18. Rather, the end of the segmented support pole 13 opposite the alternative inverted shaped plunger 15 ends in a stand 38 having a female connector 34c for attaching to the segmented support pole 13.

The alternative inverted shaped plunger 15 does not have a cone 14, but rather includes a cavity 15 that is configured and sized to receive and hold a beverage container, such as a beer can, soda bottle, juice container, or such. In practice, the alternative inverted shaped plunger 15 is primarily comprised of an elastomeric material such as rubber or plastic which by its nature provides insulation capabilities. However, the cavity 16 may include additional insulation such as Styrofoam.

FIG. 2B provides a perspective view of a third embodiment refreshment holder 100 that includes a pair of segmented support poles 13 that form assemblies 102a and 102b, which are configured with different accessories. The third embodiment refreshment holder 100 incorporates an alternate ice container 58, which is beneficially stabilized by the addition of ice 82 that is packed around the segmented support poles 13. As shown, the segmented support poles 13 are retained in position by stands 38 having female connectors 34c.

One assembly 102a (on the left in FIG. 2B) incorporates the tray 22 and the bowl 26, which are secured to its segmented support pole 13 as described above, as well as the inverted-plunger shaped beverage holder 15 having the cavity 16 (shown holding a can 88). The assembly 102b incorporates the inverted shaped plunger 12 having the cone 14 (shown holding a bottle 86). However, the assembly 102b includes a bucket 32. It is envisioned that the tray 22, the bowl 26, and the bucket 32 can be interchangeably installed onto each of the segmented support poles 13.

FIG. 3A presents a perspective view of the fourth embodiment refreshment holder 120 that includes a segmented support pole 13 as described above, but instead of a stand 38 it incorporates a pointed base 72 on the end of the segmented support pole 13. The pointed base 72 ends in a point 74 that is useful for piercing the ground to hold the fourth embodiment refreshment holder 120 upright. The pointed base 72 attaches to the end of the segmented support pole 13 using threads as described above.

FIG. 3B presents a perspective view of the fifth embodiment refreshment holder 130 that includes a segmented support pole 13 as described above, but instead of a stand 38 it incorporates a tripod base 76 on the end of the segmented support pole 13. The tripod base 76 incorporates a plurality of supports 78 which maintain the fifth embodiment refreshment holder 130 upright on flat surfaces.

While the segmented support pole 13 is described above as having three segments that is not a requirement. Other numbers of segments are envisioned. Therefore, it is to be understood that while the figures and the above description illustrate the principles of the present invention, they are exemplary only and are not intended to be exhaustive or to limit the invention to the precise forms disclosed. Therefore, the present invention is to be limited only by the appended claims.

What is claimed:

1. A refreshment holder, comprising:
a segmented pole having a first end, a second end, a first pole section, and a second pole section, wherein first and second pole sections removably mate together in such a manner that they can be separated and re-matted;
a beverage holder removably attached at a first end of said segmented pole; and
a support stand removably attached at a second end of said segmented pole, said support stand for retaining said refreshment holder in a vertical position.

2. The refreshment holder according to claim 1, wherein said beverage holder is insulating

3. The refreshment holder according to claim 2, wherein said beverage holder is in the shape of an inverted-plunger.

4. The refreshment holder according to claim 3, wherein said inverted-plunger includes a cone dimension to retain a beverage container.

5. The refreshment holder according to claim 3, wherein said inverted-plunger includes a cavity dimension to retain a beverage container.

6. The refreshment holder according to claim 1, wherein said support stand is an ice chest.

7. The refreshment holder according to claim 1, wherein said support stand is flat.

8. The refreshment holder according to claim 1, wherein said support stand is a pointed base for piercing the ground.

9. The refreshment holder according to claim 1, wherein said support stand includes three supports that form a tripod.

10. The refreshment holder according to claim 1, further including a tray removably disposed between said first pole section and said second two pole section.

11. The refreshment holder according to claim 1, further including a bowl removably disposed between said first pole section and said second two pole section.

14. The refreshment holder according to claim 1, further including a bucket removably disposed between said first pole section and said second two pole section.

15. The refreshment holder according to claim 1, wherein said first pole section includes a first threaded end, and wherein said second pole section includes a second threaded end, wherein said first threaded end and said second threaded end mate together.

16. The refreshment holder according to claim 15, wherein said beverage holder includes a third threaded end and wherein said first pole section includes a fourth threaded end, and wherein said third threaded end and said fourth threaded end mate together.

17. The refreshment holder according to claim 15, wherein said support stand includes a fifth threaded end and wherein said second pole section includes a sixth threaded end, and wherein said fifth threaded end and said sixth threaded end mate together.
